(19) United States
(12) Patent Application Publication
(10) Pub. No.: US 2007/0021884 A1
(43) Pub. Date: Jan. 25, 2007

(54) Vehicle service system and method for returning periodic maintenance mileage thereof

(75) Inventors: Kuo-Rong Chen, Panchiao City (TW); Chun-Chung Lee, Taipei (TW); Cheng-Hung Huang, Miaoli Hsien (TW)

Correspondence Address: BACON & THOMAS, PLLC, 625 SLATERS LANE, FOURTH FLOOR, ALEXANDRIA, VA, 22314, US

(73) Assignee: Sin Etke Technology Co., Ltd., Taipei City (TW)

(21) Appl. No.: 11/342,552

(22) Filed: Jan. 31, 2006

(30) Foreign Application Priority Data
Jul. 21, 2005 (TW) 094124671

(51) Int. Cl. G06F 7/00

(52) U.S. Cl. 701/30

(57) ABSTRACT

A vehicle service system and a method for returning periodic maintenance mileage thereof is disclosed. The vehicle service system is applied to a vehicle and includes a mileage counter that counts the accumulated total mileage traveled by the car, a wireless communication module, and an in-car computer, which has several predetermined mileages and corresponding event notifications pre-stored in a memory module thereof and, receives the accumulated total mileage from the mileage counter and compares the accumulated total mileage to the predetermined mileages, and drives the wireless communication module to send the corresponding event notification to a remote receiver when the accumulated total mileage is compared in conformity with one of the predetermined mileages.

### BACKGROUND OF THE INVENTION

1. Field of the Invention

The present invention relates to a vehicle service system and a method for returning periodic maintenance mileage thereof and more particularly, to a vehicle service system which can return an event notification to a service center and a method for automatically returning accumulated mileage to a service center.

2. Description of Related Art

A car is the preferred personal transportation vehicle and one of the requisites in the daily life of many people in modern times. Because a car contains more than one hundred thousand parts, an ordinary person cannot know the wearing status of every part and the way to replace the part in trouble. Therefore, the car owner will regularly drive the car to the car maintenance center for routine checks and maintenance. Normally, the car owner has to check the power of the car battery, the motor oil, the hydraulic fluid of the automatic transmission, the oil of the transmission box and the oil of the differential gear per every 1000 KM traveled by the car, and to check the gear oil of the transmission box, the hydraulic fluid of the automatic transmission, the gear oil of the differential gear, the hydraulic fluid of the power steering wheel and the motor oil per every 5000 KM traveled by the car. Additionally, further maintenance and detailed checking to be performed at the car maintenance center is necessary per every 10,000 KM or 20,000 KM traveled by the car.

However, the car owner may not watch the accumulated mileages traveled by the car during driving, and may forget to drive the car to the car maintenance center for maintenance or check. In this case, the safety coefficient of the car is lowered, and the service life of the car may be shortened.

### SUMMARY OF THE INVENTION

The present invention has been accomplished under the circumstances in view. According to one aspect of the present invention, the method for returning periodic maintenance mileage information is applied to a vehicle, which includes an in-car computer, the in-car computer further including a memory module that has stored therein at least one predetermined mileage and at least one event notification corresponding to the at least one predetermined mileage. The method comprises the steps of: (a) counting the mileage traveled by the vehicle and accumulating the counted mileage so as to obtain an accumulated total mileage; (b) comparing the accumulated total mileage to the at least one predetermined mileage stored in the memory module of the in-car computer; and (c) sending the event notification corresponding to the accumulated total mileage to a remote receiver through a wireless communication module configured in the vehicle when the accumulated total mileage is compared in conformity with one of the at least one predetermined mileage.

According to another aspect of the present invention, the vehicle service system is applied to a vehicle, comprising a mileage counter, a wireless communication module, and an in-car computer. The mileage counter is adapted to count the mileage traveled by the vehicle and to accumulate the counted mileage so as to obtain an accumulated total mileage. The in-car computer is electrically connected to the mileage counter and the wireless communication module. The in-car computer includes a memory module, which has stored therein at least one predetermined mileage and at least one event notification corresponding to the at least one predetermined mileage. The in-car computer is adapted to receive the accumulated total mileage from the mileage counter and to compare the accumulated total mileage to the at least one predetermined mileage and to drive the wireless communication module to send the event notification corresponding to the accumulated total mileage to a remote receiver when the accumulated total mileage is compared in conformity with one of the at least one predetermined mileage.

The invention further comprises an on-vehicle warning device electrically connected to the in-car computer and controlled by the in-car computer to output a corresponding warning signal when the accumulated total mileage is compared by the in-car computer and determined to be in conformity with one of the at least one predetermined mileage. The on-vehicle warning device can be an on-vehicle stereo system, a buzzer, an LED (light emitting diode), or an LCD.

Further, the wireless communication module can be a GSM (Global System for Mobile Communication) module, a GPRS (General Packet Radio Service) module, a WCDMA (Wideband Code Division Multiple Access) module, a 3G wireless module, a PHS (Personal Handphone System) module, a UWB (Ultra Wideband) module, a Bluetooth™ module, or any of a variety of other equivalent wireless communication modules.

Further, the remote receiver is installed in a remote Customer Service Center, the memory module has stored therein the wireless communication address of the remote Customer Service Center (for example, the telephone number, e-mail address, fax number). The in-car computer controls the wireless communication module to send corresponding event notification to the remote receiver subject to the wireless communication address of the remote customer service center. When the remote receiver receives the corresponding event notification, the remote receiver informs the user of the vehicle by means of at least one of message media of: voice message, short text message, fax message, airmail, and e-mail.

### BRIEF DESCRIPTION OF THE DRAWINGS

FIG. 1 is a block diagram according to the preferred embodiment of the present invention.

FIG. 2 is a flow chart according to the preferred embodiment of the present invention.

### DETAILED DESCRIPTION OF THE PREFERRED EMBODIMENT

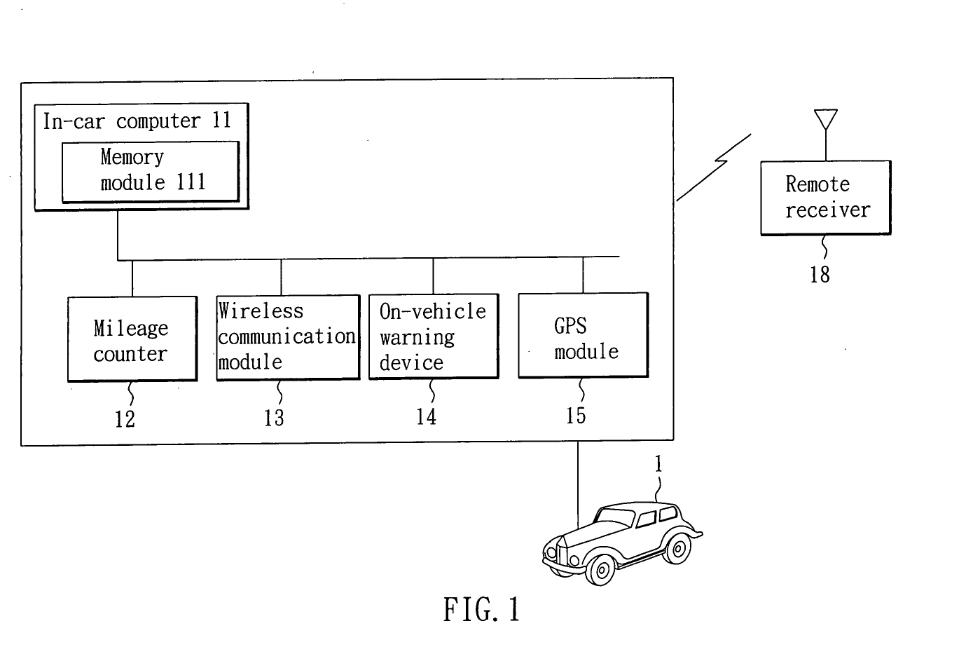

Referring to FIG. 1, a vehicle service system is shown applied to a car 1. The vehicle service system includes an in-car computer 11, a mileage counter 12, a wireless communication module 13, an on-vehicle warning device 14, and a GPS (Global Positioning System) module 15. Further, the in-car computer 11 includes a memory module 111.

The in-car computer 11 is electrically and respectively connected to the mileage counter 12, the wireless communication module 13, the on-vehicle warning device 14 and the GPS module 15. The mileage counter 12 is adapted to count the mileage traveled by the car, to accumulate the counted mileages, and to send the data of the accumulated total mileages to the in-car computer 11 for storing in the memory module 111.

According to this embodiment, the memory module 111 has stored therein several predetermined mileages, for example, multiples of 5,000 KMs, such as 5,000 KMs, 10,000 KMs, 15,000 KMs, 20,000 KMs, etc. In another embodiment of the present invention, the memory module 111 has stored therein several predetermined mileages that are multiples of 1,000 KMs, such as 10,000 KMs, 20,000 KMs, 30,000 KMS, 40,000 KMs, etc. The memory module also has stored therein several event notifications corresponding to the several predetermined mileages, and the wireless communication address of a remote call center, for example, the telephone number, e-mail address or fax number of the remote call center. The event notification can be, for example, the notification for change of motor oil and oil filter when the accumulated total mileages reaches 5,000 KMs.

According to this embodiment, the wireless communication module 13 is a GSM (Global System for Mobile Communication) module. Alternatively, the wireless communication module 13 can be a GPRS (General Packet Radio Service) module, a WCDMA (Wideband Code Division Multiple Access) module, a 3G wireless module, a PHS (Personal Handphone System) module, a UWB (Ultra Wideband) module, or a Bluetooth™ module.

The on-vehicle warning device 14 is an LCD that displays a flashing message to attract the car owner's attention. In other embodiments of the present invention, the warning device 14 can be an on-vehicle stereo system, a buzzer, an LED (light emitting diode), or any of a variety of on-vehicle sound and visual signal means.

The operation of the present invention is detailed as follows.

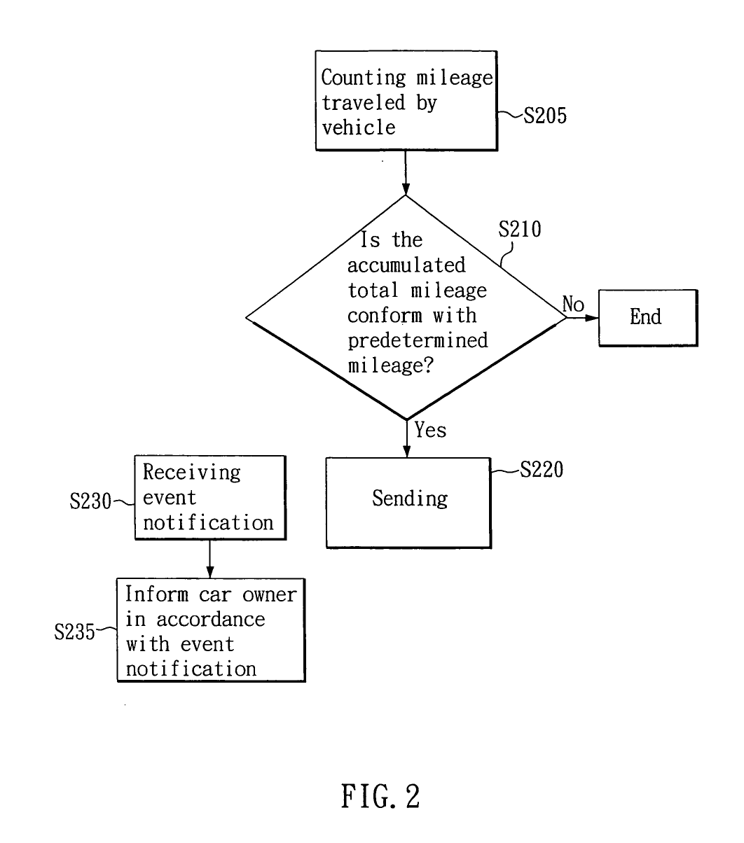

FIG. 2 shows the flow chart of the preferred embodiment of the present invention. First, the mileage counter 12 constantly counts the accumulated mileage traveled by the car during running of the car and sends the data of the accumulated total mileage to the in-car computer 11, enabling the in-car computer 11 to store the data of the accumulated total mileage in the memory module 111 (Step S205). Further, the in-car computer 11 compares the data of the accumulated total mileage received from the mileage counter 12 to the several predetermined mileages stored in the memory module 111, and determines if the accumulated total mileage is compared in conformity with one of the predetermined mileages (Step S210).

If the accumulated total mileage does not conform with any predetermined mileage, the mileage counter 12 keeps counting the mileage traveled by the car. If the accumulated total mileage is compared in conformity with one of the predetermined mileages, for example, if the accumulated total mileage is 10,000 KMs and the memory module 111 has stored therein the predetermined mileage of 10,000 KMs, the in-car computer 11 immediately controls the wireless communication module 13 to send an event notification corresponding to 10,000 KMs to the remote receiver 18 (Step S220).

The format of the event notification can be a short text message, a pre-recorded voice message, a multimedia video file, an e-mail, or any of a variety of other equivalent messages that can be sent by the wireless communication module 13. Upon receipt of the event notice from the wireless communication module 13, the remote receiver 18 converts the format of the event notice and outputs the converted message through the Internet or a telecommunication network to a terminal, for example, a fax machine.

According to this embodiment, the remote receiver 18 is installed in the remote Customer Service Center (for example, the Call Center). When the remote receiver 18 receives an event notification (Step S230), the serviceman of the call center will inform the owner of the car 1 subject to the content of the event notification (Step S235), informing the car owner to send the car 1 to the car maintenance center for routine check and maintenance. Each event notification contains the data of car license number and accumulated total mileage data. Therefore, the serviceman of the call center can inquire the database subject to the car license number contained in the content of the received event notification for the basic data and condition of use of the car 1, and then send a voice notification, short text message, e-mail, conventional airmail, fax message, or the like to the car owner, advising the car owner to send the car 1 back to the car maintenance center for a routine check and maintenance at a proper time.

In another embodiment of the present invention, the memory module 111 has stored therein only one predetermined mileage data, such as the default value of 5,000 KMs. When the in-car computer 11 determines the accumulated total mileage data to be in conformity with the pre-stored predetermined mileage data, the in-car computer 11 immediately controls the wireless communication module 13 to send an event notification to the remote receiver 18. After the car 1 has been sent to the car maintenance center, the maintenance engineer can change the default value in the memory module 111, for example, changing the predetermined mileage data from the original 5,000 KMs to 10,000 KMs or 8,000 KMs at which a next routine check and maintenance work is needed. Therefore, the maintenance engineer can alter the default value in the memory module 111 subject to the actual condition of the car, thereby providing a flexible maintenance service.

Further, the in-car computer 11 is electrically connected to the GPS module 15 which receives signals from several artificial satellites so as to obtain positioning data (for example, coordinates location data). Therefore, when the in-car computer 11 controls the wireless communication module 13 to send a corresponding event notification to the remote receiver 18, the current location data of the car 1 can be contained in the content of the event notification so that the serviceman of the call center can compare the location data of the car 1 to an electronic map to estimate the movement area of the car 1 and to find a nearby car maintenance center for the owner of the car 1, providing a convenient service to the client.

In view of the foregoing, the invention stores the several predetermined mileage data into the memory module so that when the accumulated total mileage of the car is compared in conformity with one of the predetermined mileage data, the in-car computer immediately controls the wireless communication module to send a corresponding event notification to the remote receiver, enabling the servicemen to inform the car owner to drive the car to the car maintenance center for a periodic maintenance and maintenance at a proper time.

Although the present invention has been explained in relation to its preferred embodiments, it is to be understood that many other possible modifications and variations can be made without departing from the spirit and scope of the invention as hereinafter claimed.

What is claimed is:

1. A method for returning periodic maintenance mileage information applied to a vehicle including an in-car computer, the in-car computer further including a memory module storing therein at least one predetermined mileage and at least one event notification corresponding to the at least one predetermined mileage, the method comprising the steps of:
(a) counting the mileage traveled by the vehicle and accumulating the counted mileage so as to obtain an accumulated total mileage;
(b) comparing the accumulated total mileage to the at least one predetermined mileage stored in the memory module of the in-car computer; and
(c) sending the event notification corresponding to the accumulated total mileage to a remote receiver through a wireless communication module configured in the vehicle when the accumulated total mileage is compared in conformity with one of the at least one predetermined mileage.

2. The method as claimed in claim 1, wherein the vehicle further includes an on-vehicle warning device electrically connected to the in-car computer and controlled by the in-car computer to output a corresponding warning signal when the accumulated total mileage is compared by the in-car computer to be in conformity with one of the predetermined mileages.

3. The method as claimed in claim 2, wherein the on-vehicle warning device is selected from one of the devices of an on-vehicle stereo system, a buzzer, an LED (light emitting diode), and an LCD.

4. The method as claimed in claim 1, wherein the wireless communication module is selected from one of apparatuses of a GSM (Global System for Mobile Communication) module, a GPRS (General Packet Radio Service) module, a WCDMA (Wideband Code Division Multiple Access) module, a 3G wireless module, a PHS (Personal Handphone System) module, a UWB (Ultra Wideband) module, and a Bluetooth™ module.

5. The method as claimed in claim 1, wherein when the remote receiver receives the corresponding event notification, the remote receiver informs the user of the vehicle by means of at least one of message media of: voice message, short text message, fax message, airmail, and e-mail.

6. The method as claimed in claim 1, wherein the remote receiver is installed in a remote customer service center; the memory module has stored therein the wireless communication address of the remote customer service center; the in-car computer controls the wireless communication module to send the corresponding event notification to the remote receiver subject to the wireless communication address of the remote customer service center.

7. A vehicle service system applied to a vehicle, the vehicle service system comprising:
a mileage counter adapted to count the mileage traveled by the vehicle and to accumulate the counted mileage so as to obtain an accumulated total mileage;
a wireless communication module; and
an in-car computer electrically connected to the mileage counter and the wireless communication module, the in-car computer including a memory module, the memory module having stored therein at least one predetermined mileage and at least one event notification corresponding to the at least one predetermined mileage, the in-car computer being adapted to receive the accumulated total mileage from the mileage counter and to compare the accumulated total mileage to the at least one predetermined mileage and to drive the wireless communication module to send the event notification corresponding to the accumulated total mileage to a remote receiver when the accumulated total mileage is compared in conformity with one of the at least one predetermined mileage.

8. The vehicle service system as claimed in claim 7, further comprising an on-vehicle warning device electrically connected to the in-car computer and adapted to output a warning signal when the accumulated total mileage is compared by the in-car computer to be in conformity with one of the at least one predetermined mileage.

9. The vehicle service system as claimed in claim 8, wherein the on-vehicle warning device is selected from one of devices of an on-vehicle stereo system, a buzzer, an LED (light emitting diode), and an LCD.

10. The vehicle service system as claimed in claim 7, wherein the wireless communication module is selected from one of apparatuses of a GSM (Global System for Mobile Communication) module, a GPRS (General Packet Radio Service) module, a WCDMA (Wideband Code Division Multiple Access) module, a 3G wireless module, a PHS (Personal Handphone System) module, a UWB (Ultra Wideband) module, and a Bluetooth™ module.

11. The vehicle service system as claimed in claim 7, wherein when the remote receiver receives the corresponding event notification, the remote receiver informs the user of the vehicle by means of at least one of message media of: voice message, short text message, fax message, airmail, and e-mail.

12. The vehicle service system as claimed in claim 7, wherein the remote receiver is installed in a remote customer service center; the memory module has stored therein the wireless communication address of the remote customer service center; the in-car computer controls the wireless communication module to send the corresponding event notification to the remote receiver subject to the wireless communication address of the remote customer service center.
